(19) United States
(12) Patent Application Publication
(10) Pub. No.: US 2014/0030050 A1
(43) Pub. Date: Jan. 30, 2014

(54) TRANSMISSION APPARATUS

(71) Applicants: Wai Kean Chan, Singapore (SG); Kar Woh Fok, Singapore (SG); Eng Kuan Eikky Lim, Singapore (SG); Chee Teck Ong, Singapore (SG); Madan Pushpakath, Singapore (SG); Sheau Yeng Wei, Singapore (SG)

(72) Inventors: Wai Kean Chan, Singapore (SG); Kar Woh Fok, Singapore (SG); Eng Kuan Eikky Lim, Singapore (SG); Chee Teck Ong, Singapore (SG); Madan Pushpakath, Singapore (SG); Sheau Yeng Wei, Singapore (SG)

(73) Assignee: VENTURE CORPORATION LIMITED, Singapore (SG)

(21) Appl. No.: 14/003,031

(22) PCT Filed: Mar. 5, 2012
(86) PCT No.: PCT/SG12/00071

§ 371 Date: Sep. 4, 2013

(30) Foreign Application Priority Data
Mar. 4, 2011 (SG) 201101635-9

(51) Int. Cl. G11B 33/04

(52) U.S. Cl. CPC G11B 33/04
USPC 414/281

(57) ABSTRACT

A transmission apparatus for use in a stack of data library units, the stack comprising a lower data library unit and an upper data library unit, each data library unit of the stack comprising a plurality of upright frames, the transmission apparatus comprising a tray for transporting a tape cartridge; a plurality of positioning pinions rotatably attached to the tray; a plurality of racks each disposed on each of the plurality of upright frames and configured to be engaged by the corresponding plurality of positioning pinions for vertical positioning of the tray within each data library unit; a plurality of partial racks each comprising an upper tooth and a lower tooth disposed adjacent the plurality of racks at each of the plurality of upright frames, the upper tooth being disposed adjacent a lower end of the frame of the upper data library unit and the lower tooth being disposed adjacent an upper end of the frame of the lower data library unit; a plurality of cross-over pinions each rotatably attached to the tray and disposed co-axially with each of the plurality of positioning pinions, each cross-over pinion having a tooth profile configured to engage each of the partial racks for effecting movement of the tray between the lower data library unit and the upper data library unit.

### TECHNICAL FIELD

This invention relates generally to a transmission apparatus for tape cartridge handling, and relates more particularly, though not exclusively, to a transmission apparatus for tape cartridge handling in a stack of data library units.

### BACKGROUND

A transmission apparatus typically has a tray for supporting a loading robot to be moved along a vertical axis of movement in order to access a plurality of tape slots within a data library. In some embodiments, the tray may be moved vertically by means of a rack-and-pinion system wherein positioning pinions which are attached to the tray rotatably engage vertically disposed racks which are attached to a housing of the data library.

Normally, one data library unit is provided with one transmission apparatus. To increase storage without a substantial increase in cost, multiple data library units each comprising a plurality of tape slots may be stacked one on top of another to form a stack of multiple data library units. In this way, it is possible to have only a single transmission apparatus with one loading robot to serve the stack of multiple data library units, thus reducing the number of transmission apparatuses required.

However, there are problems associated with providing only one transmission apparatus with one loading robot serving a stack of multiple data library units. Such problems include requiring an installer or user to adjust individual racks in each data library to achieve a desired alignment of matching racks from one data library to the next data library in order for the pinions on the tray to be able to rotate seamlessly and cross-over from one data library unit to its vertically adjacent data library unit. Without human intervention to correct mis-alignment of matching racks, the tray will be unable to make the cross-over successfully.

Besides the tray being mechanically hindered from moving from one data library unit to the next due to rack misalignment, manual adjustment of racks also gives rise to cummulative stack-up errors as the number of data library units in the stack increases. This is due to the stack of multiple library units having only one reference home flag which is normally provided at the lowest data library unit that serves as a global reference for all the tape slots in the stack of multiple data library units. Because the cummulative stack-up errors eventually become larger than each tape slot can tolerate, there is thus a limit to the number of data library units that may be stacked in order to still be able to accurately access the tape slots in the highest data library unit in the stack.

Normally, the loading robot on the tray is controlled by a flexible flat cable (FFC) that connects a printed circuit board (PCB) on the tray to a PCB connected to a motherboard. In order for the tray to travel greater vertical distances within a stack of multiple data library units, the FFC must be able to extend and retract accordingly as the tray moves farther or nearer the motherboard respectively. Currently, a spooler is normally provided that uses an extension spring to provide a retractive force to the FFC. As the FFC extends while the tray moves away from the spool that is positioned at a housing of the stack, the spool is unwound, thereby extending the extension spring. The retractive force exerted by the extension spring on the FFC increases proportionately to the amount of extension experienced by the extension spring, according to Hooke's Law. This results in the FFC experiencing increasing tension with increasing extension of the extension spring the tray travels further from the spool. Such increase in tensile stress experienced by the FFC reduces its overall life span.

### SUMMARY

According to a first aspect, there is provided a transmission apparatus for use in a stack of data library units, the stack comprising a lower data library unit and an upper data library unit, each data library unit of the stack comprising a plurality of upright frames, the transmission apparatus comprising: a tray for transporting a tape cartridge; a plurality of positioning pinions rotatably attached to the tray; a plurality of racks each disposed on each of the plurality of upright frames and configured to be engaged by the corresponding plurality of positioning pinions for vertical positioning of the tray within each data library unit; a plurality of partial racks each comprising an upper tooth and a lower tooth disposed adjacent the plurality of racks at each of the plurality of upright frames, the upper tooth being disposed adjacent a lower end of the frame of the upper data library unit and the lower tooth being disposed adjacent an upper end of the frame of the lower data library unit; a plurality of cross-over pinions each rotatably attached to the tray and disposed co-axially with each of the plurality of positioning pinions, each cross-over pinion having a tooth profile configured to engage each of the partial racks for effecting movement of the tray between the lower data library unit and the upper data library unit.

The positioning pinions may be corotational with the plurality of cross-over pinions.

The plurality of racks may be toothless when adjacent the plurality of partial racks.

The transmission apparatus may further comprise a plurality of bearings attached to the tray and configured to engage a corresponding plurality of vertically disposed surfaces provided in the corresponding plurality of frames, each of the plurality of bearings being disposed coaxially with each of the plurality of positioning pinions such that an optimal horizontal distance between the plurality of positioning pinions and corresponding plurality of racks is maintained during movement of the tray.

A lower surface of the upper tooth may be materially reduced to avoid interference between a tooth of the cross-over pinion and the partial rack when a pitch to pitch distance between the upper tooth and the lower tooth is minimized.

An upper surface of a tooth of the cross-over pinion may be materially reduced to avoid interference between the tooth of the cross-over pinion and the partial rack when a pitch to pitch distance between the upper tooth and the lower tooth is minimized.

According to a second exemplary aspect, there is provided a transmission apparatus for use in a stack of data library units, the stack comprising a lower data library unit and an upper data library unit, the transmission apparatus comprising: a tray for transporting a tape cartridge; a flexible cable communicatively connecting the tray and a motherboard; a spool for winding the flexible cable therearound to retract the flexible cable when the tray moves towards the spool and unwinding the flexible cable therefrom to extend the flexible cable when the tray moves away from the spool; and a weight configured to provide a constant retractive force to wind the flexible cable around the spool.

The spool may be rotatably connected to the weight via a cable of a pulley system.

The cable may be configured to wind up around the spool when the flexible cable is unwound from the spool.

The weight may be configured to rotate the spool in one direction while extension of the flexible cable due to movement of the tray away from the spool is configured to rotate the spool in an opposite direction.

According to a third aspect, there is provided a stack of data library units comprising the transmission apparatus described above.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a perspective schematic view of an exemplary embodiment of a transmission apparatus;

FIG. 2 is a schematic isometric view of a cross-over configuration provided in the transmission apparatus of FIG. 1;

FIG. 3a is another schematic isometric view of the cross-over configuration of FIG. 2;

FIG. 3b is a schematic isometric cross-sectional view of a bearing in the cross-over configuration of FIG. 3a;

FIG. 3c is a schematic isometric cross-sectional view of a positioning pinion in the cross-over configuration of FIG. 3a;

FIG. 3d is a schematic isometric cross-sectional view of a cross-over pinion and rack in the cross-over configuration of FIG. 3a;

FIG. 4a is a schematic side view of the bearing of FIG. 3b when the positioning pinion of FIG. 3c is preparing to transfer power transmission to the cross-over pinion of FIG. 3d;

FIG. 4b is a schematic side view of the positioning pinion of FIG. 3c when the positioning pinion of FIG. 3c is preparing to transfer power transmission to the cross-over pinion of FIG. 3d;

FIG. 4c is a schematic side view of the cross-over pinion of FIG. 3d when the positioning pinion of FIG. 3c is preparing to transfer power transmission to the cross-over pinion of FIG. 3d;

FIG. 5a is a schematic side view of the bearing of FIG. 3b when the cross-over pinion of FIG. 3d is engaged to effect the cross-over from a lower data library unit to an upper data library unit;

FIG. 5b is a schematic side view of the positioning pinion of FIG. 3c when the cross-over pinion of FIG. 3d is engaged to effect the cross-over from a lower data library unit to an upper data library unit;

FIG. 5c is a schematic side view of the cross-over pinion of FIG. 3d when the cross-over pinion of FIG. 3d is engaged to effect the cross-over from a lower data library unit to an upper data library unit;

FIG. 6a is a schematic side view of the bearing of FIG. 3b during the cross-over from a lower data library unit to an upper data library unit;

FIG. 6b is a schematic side view of the positioning pinion of FIG. 3c during the cross-over from a lower data library unit to an upper data library unit;

FIG. 6c is a schematic side view of the cross-over pinion of FIG. 3d during the cross-over from a lower data library unit to an upper data library unit;

FIG. 7a is a schematic side view of the bearing of FIG. 3b when the positioning pinion of FIG. 3c is preparing to resume power transmission;

FIG. 7b is a schematic side view of the positioning pinion of FIG. 3c when the positioning pinion of FIG. 3c is preparing to resume power transmission;

FIG. 7c is a schematic side view of the cross-over pinion of FIG. 3d when the positioning pinion of FIG. 3c is preparing to resume power transmission;

FIG. 8a is a schematic side view of the bearing of FIG. 3b when the positioning pinion of FIG. 3c has resumed power transmission;

FIG. 8b is a schematic side view of the positioning pinion of FIG. 3c when the positioning pinion of FIG. 3c has resumed power transmission;

FIG. 8c is a schematic side view of the cross-over pinion of FIG. 3d when the positioning pinion of FIG. 3c has resumed power transmission;

FIG. 9 is a schematic isometric view of a spooler in a stack of data library units;

FIG. 10 is a schematic isometric cross-sectional view of the spooler of FIG. 9; and

FIG. 11 is a schematic closer up view of the spooler of FIG. 10 shown without a housing.

### DETAILED DESCRIPTION OF EXEMPLARY EMBODIMENTS

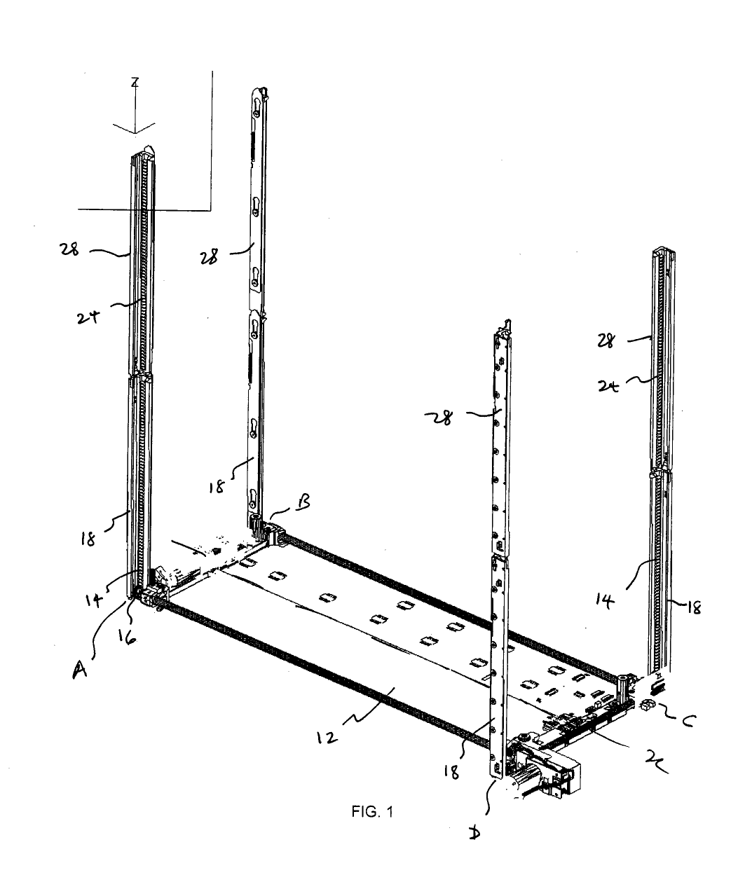

An exemplary transmission apparatus 10 will be described with reference to FIGS. 1 to 11 below.

As can be seen in FIG. 1, the transmission apparatus 10 is largely symmetrical about a horizontal axis X. The transmission apparatus 10 includes a rectangular tray 12 for transporting a tape cartridge. The tray 12 is provided with a pinion gear or positioning pinion 16 at, immediately adjacent, adjacent or near each of the four corners A, B, C, D of the tray 12. The tray 12 thus has four positioning pinions 16 rotatably attached thereto.

The four positioning pinions 16 are configured to rotatably engage upright or vertically disposed racks 14, 24 provided at corresponding four corners of each data library unit in the stack of data library units (not shown). Each data library unit is thus provided with four racks 14 or 24 for effecting movement and precise positioning of the tray 12 within that data library unit as the positioning pinions 16 engage the respective racks 14 or 24. Each rack 14, 24 is mounted to and supported by an upright or vertically disposed frame 18, 28 of a data library unit. The frames 18, 28 may be of any suitable material or shape provided they are substantially rigid, given their purpose. The racks 14, 24 are configured to be engaged by the four positioning pinions 16 rotatably therealong. As can be seen, the racks 14 of a lower data library unit match up with the racks 24 of an adjacent upper data library unit in order to allow the positioning pinions 16 to move between the lower and upper data library units.

To overcome the need for precise manual adjustment to the alignment between adjacent racks 14,24, the transmission apparatus 10 is provided with a cross-over configuration as shown in FIG. 2, at each of the four corners between adjacent data library units in the stack. The cross-over configuration 30 comprises a partial rack-and-pinion profile. This includes a partial rack 31 provided alongside the racks 14, 24 and adjacent the meeting ends 19, 29 of each frame 18, 28 respectively. The partial rack 31 comprises a lower tooth 32 and an upper tooth 34. The lower tooth 32 is provided at the upper end 19 of the frame 18 of the lower data library unit, while the upper tooth 34 is provided at the lower end 29 of the frame 28 of the upper data library unit. The lower tooth 32 and upper tooth 34 have profiles configured to engage a tooth 36 and an adjacent tooth surface 38 of a partial pinion gear or cross-over pinion 35 that is comprised in the cross-over configuration 30.

Each cross-over pinion 35 is attached to the corner A, B, C and D of the tray 12 and configured to be coaxial with a corresponding positioning pinion 16, and to also corotate with the positioning pinion 16. Preferably, a single shaft 40 is provided to drive both the positioning pinion 16 and the cross-over pinion 35. The positioning pinion 16 and the cross-over pinion 35 may be integrally formed with each other in order to be provided as a single compound spur gear 26 at each corner of the tray 12. Adjacent where the partial rack 31 is located, the racks 14, 24 are configured to be toothless so as to cease engagement with the positioning pinion 16 when the cross-over configuration 30 is effecting movement of the tray 12 between adjacent data library units.

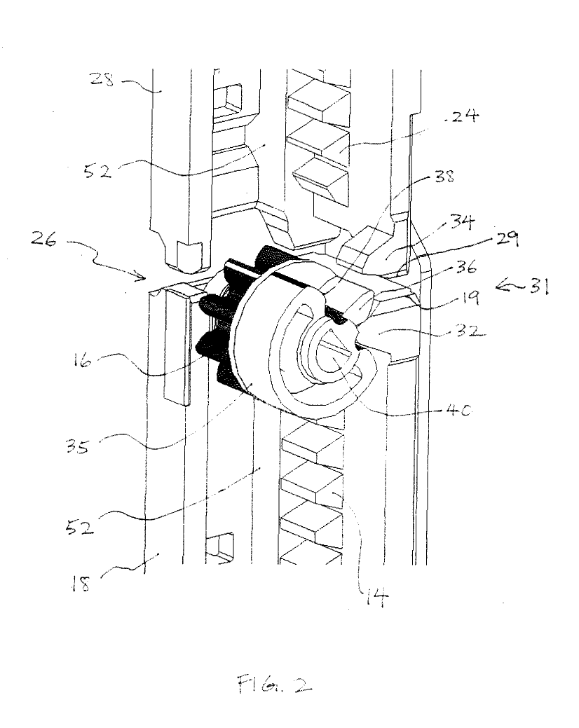

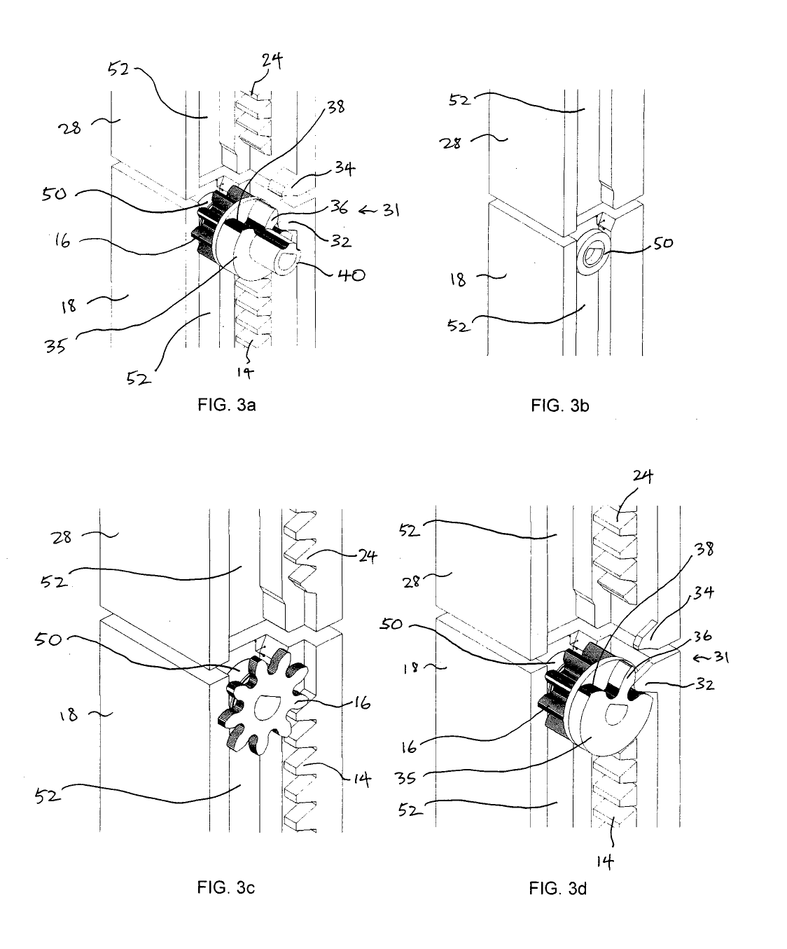

The shaft 40 is preferably constrained to move vertically at an optimal horizontal distance from the racks 14, 24 in order to achieve the greatest power transmission possible during movement of the tray 12. This may be achieved by providing a bearing 50 as shown in FIGS. 3b, 4a, 5a, 6a,7a and 8a that is preferably also mounted on the shaft 40 and coaxial with the positioning pinion 16 and cross-over pinion 35. The bearing 50 is configured to engage a vertical surface 52 provided in each of the frames 18, 28, thereby maintaining the optimal horizontal distance mentioned above. The vertical surface 52 may be provided by means of a slot 52 provided in the frames 18, 28. Preferably, the bearing 50 is configured to have a rolling engagement with the vertical surface 52 to minimize frictional losses.

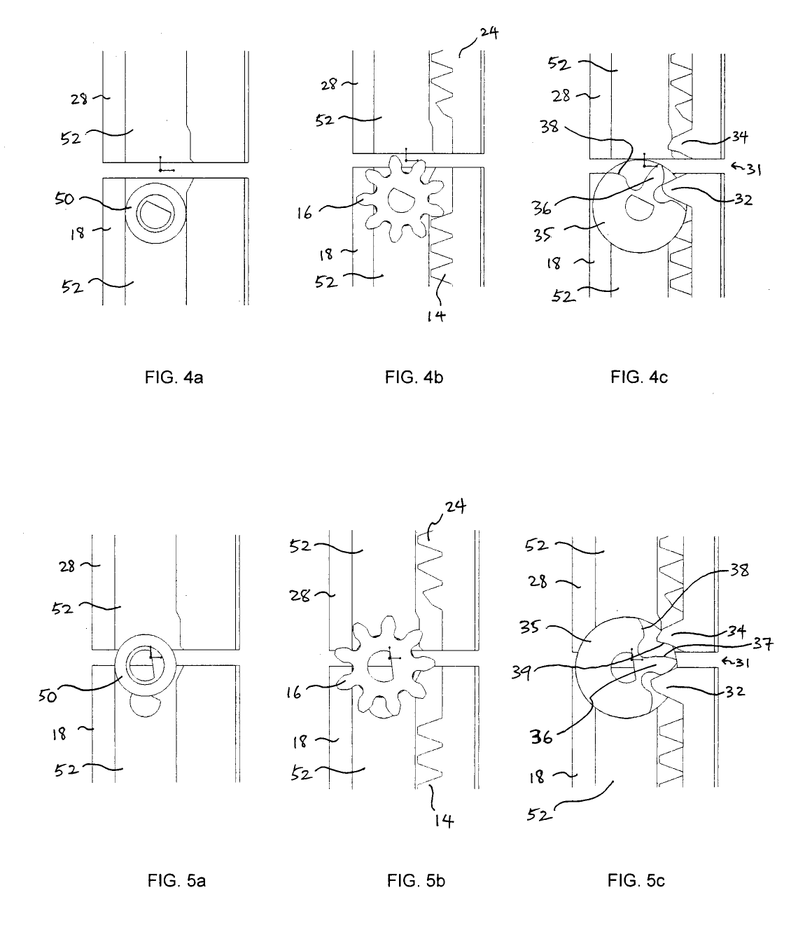

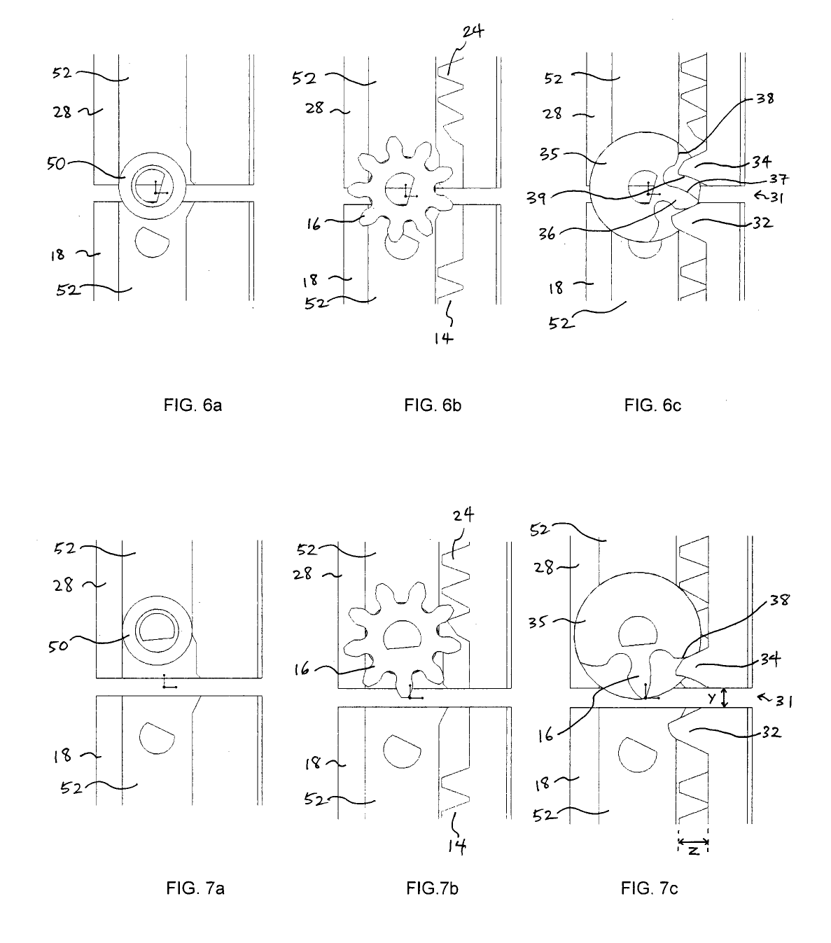

As shown in FIGS. 4a to 4c, when the tray 12 (hidden) is moving up and is at the top of a lower data library unit having racks 14, the positioning pinion 16 is at a point of the rack 14 where the rack 14 just ceases to have any teeth. At the same time, the cross-over pinion 35 is at a point where the single tooth 36 is at a point of first engagement with the lower tooth 32 of the partial rack 31. As the shaft 40 continues to rotate to move the tray 12 upwards, the tooth 36 of the cross-over pinion 35 engages the lower tooth 32 of the partial rack 31 to push the tray 12 upwards, thereby crossing over from the lower data library unit to the upper data library unit as shown in FIGS. 5c and 6c. During the crossing over, the positioning pinion 16 is free from engagement with any teeth of the racks 14, 24, as shown in FIGS. 5b and 6b. The bearing 50 continues to be slideably constrained by the vertical slot 52 of the frames 18, 28 to maintain an optimal horizontal distance between the positioning pinions 16 and the racks 14, 24, as shown in FIGS. 5a and 6a.

When the crossing over is just completed as shown in FIGS. 7a to 7c, the bearing 50 now engages the vertical slot 52 provided in the frame 28 of the upper data library to maintain the optimal horizontal distance. The positioning pinion 16 is at a point of first engagement with the teeth of the rack 24 of the upper data library in readiness to take over power transmission from the cross-over pinion 35. The tooth 36 of the cross-over pinion 35 has disengaged with the lower tooth 32 of the partial rack 31, while the tooth surface 38 which was in engagement with the upper tooth 34 of the partial rack 31 has now reached an end of its gear profile.

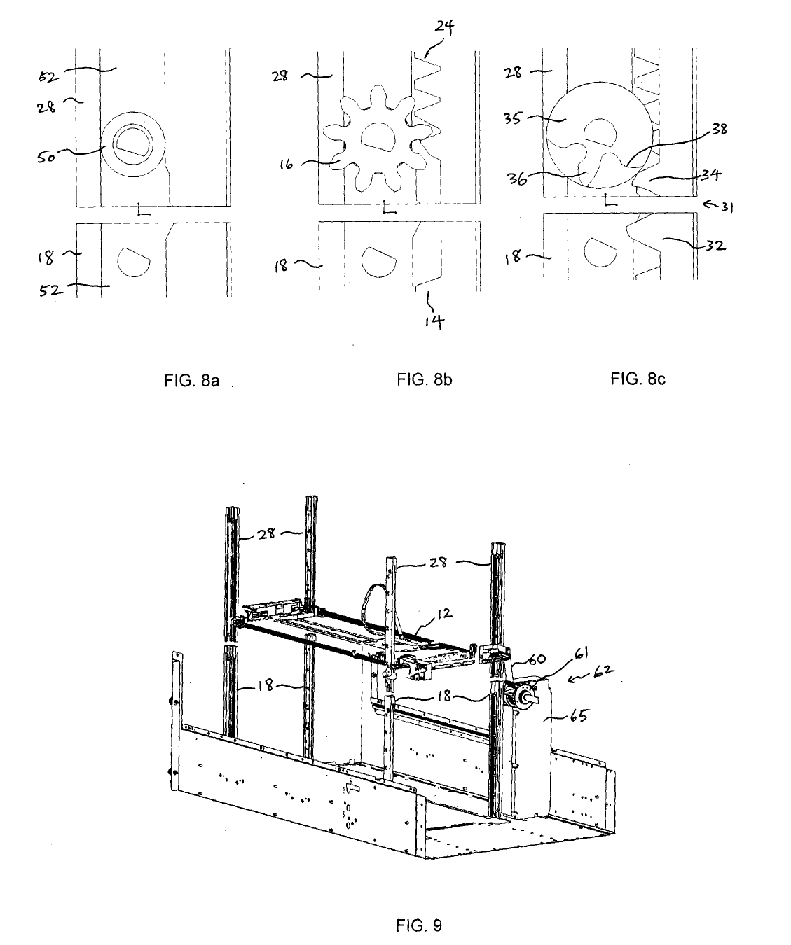

As the tray 12 moves fully into the upper data library unit after crossing over has been effected, as can be seen in FIGS. 8a to 8c, the positioning pinion 16 engages the rack 24 of the upper data library unit to take over normal movement and positioning within the upper data library unit. The cross-over configuration 30 ceases to function, there being no longer any engagement or meshing between the cross-over pinion 35 and the partial rack 31.

The partial rack 31 and pinion 35 gear profile has the following characteristics to tolerate a much larger misalignment between the two rack teeth 32, 34:
A) larger gear module and pressure angle; and
B) reduced material at coast side 37, 39 that gives rise to bigger backlash.

These characteristics are important to compensate for the inherent misalignment and tolerance stack where the two rack teeth 32, 34 meet.

A) Larger Gear Module and Pressure Angle

In order to tolerate variation in pitch to pitch distance of the rack teeth 32, 34, it is important to keep the norminal pitch distance as large as possible. In one embodiment, the ratio of tolerance stack and norminal pitch distance was kept at not greater than 0.33 as shown in equation (1) below.

$$\frac{Tolerance Stack}{Norminal Pitch Distance} = \frac{ɛ}{ρ} \leq ∼ 0.33 \qquad ( 1 )$$

A larger pressure angle of 25 degrees is used instead of the more common 20 degrees. This pressure angle of 25 degrees allows a more generous entry angle of gear mesh between the cross-over pinion tooth 36 and the partial rack lower tooth 32. The surface stress is also reduced, thereby reducing wear rate due to sliding motion. However, a much larger pressure angle is not suitable as it undesirably decreases the top land width.

B) Reduced Material at Coast Side 37, 39 that Gives Rise to Bigger Backlash

The cross-over configuration 30 relies on gravitational force to keep the cross-over pinion 35 to be always driven on a single side of the involute profile of its tooth flank. This allows deviation in the involute profile on a coast side 37 or upper tooth surface 37 of the cross-over pinion 35, as shown in FIGS. 5c and 6c. This reduction in material is necessary to allow a smaller pitch to pitch distance y between the teeth 32, 34 of the partial rack 31.

Similarly, material reduction at a coast side 39 or lower surface 39 of the upper tooth 34 of the partial rack 31 is introduced as shown in FIGS. 5c and 6c. This reduction is to avoid any interference between the cross-over pinion tooth 36 and the upper tooth 34 of the partial rack 31 when a pitch distance y between the teeth 32, 34 of the partial rack 31 is at its smallest or minimized.

Experiments were conducted to study and characterize the operation and mechanism of the cross-over configuration 30 by using a jig which was capable of changing the pitch to pitch distance between the teeth 32, 34 of the partial rack 31. A total of 8 hypothetical scenarios or worst cases were studied as shown in Table 1 below, where Y Gap refers to the pitch distance y as shown in FIG. 7c, while Z-offset is the distance z as shown in FIG. 7c.

TABLE 1

| | Front Right | | Front Left | | Rear Right | | Rear Left | |
|---|---|---|---|---|---|---|---|---|
| Config- | | Z- | | Z- | | Z- | | Z- |
| uration | Y | off- | Y | off- | Y | off- | Y | off- |
| No. | Gap | set | Gap | set | Gap | set | Gap | set |
| WC1 | 1 | −0.5 | 1 | +0.5 | 1 | −0.5 | 1 | −0.5 |
| WC2 | 1 | +0.5 | 1 | −0.5 | 1 | +0.5 | 1 | +0.5 |
| WC3 | 3 | −0.5 | 3 | +0.5 | 3 | −0.5 | 3 | −0.5 |
| WC4 | 3 | +0.5 | 3 | −0.5 | 3 | +0.5 | 3 | +0.5 |
| WC5 | 3 | −0.5 | 3 | +0.5 | 1 | −0.5 | 1 | −0.5 |
| WC6 | 3 | +0.5 | 3 | −0.5 | 1 | +0.5 | 1 | +0.5 |
| WC7 | 1 | −0.5 | 1 | +0.5 | 3 | −0.5 | 3 | −0.5 |
| WC8 | 1 | +0.5 | 1 | −0.5 | 3 | +0.5 | 3 | +0.5 |

The characterization results were found to be satisfactory, with the cross-over configuration 30 having a working reliability of over 150K cycles.

By providing two rack-and-pinion systems 14,24-16 and 31-35 running coaxially, cummulative stack up errors previously experienced can be avoided by not relying on only one global reference as used in the prior art. Instead, individual racks 14 or 24 in each data library unit can take its own position with reference to its own home flag within its own data library unit instead of with reference to a single global reference located at the lowest data library unit in the stack of data library units. As each data library unit has its own home flag, the transmission apparatus 10 can take reference from that home flag when moving within that data library unit. In this way, the stack of data library units functions as if they were independent datal library units, but served by only one transmission apparatus 10. This also minimizes reconstruction and part replacement of existing transmission apparatus used in single data library units when the transmission apparatus is to be adapted for use in a stack of data library units.

Similarly, reconstruction and part replacement in existing single data library units can also be minimized since such single data library units already come with reference features such as a reference home flag on the chassis, a reference fiducial target on some magazine slot, and an advanced non-contact optical sensing solution on the loading robot. The present invention thus allows reuse of these reference features by creating a bridge between two independent data library units. In addition, an encoder sensor is preferably provided to work with the corresponding flag of each data library unit in order to tell a control system whether the transmission apparatus 10 is inside or working within the racks 14 or 24 of the data library unit, or at the cross-over region between two data library units.

Within a stack of data library units as depicted in FIG. 9 (only the frames 18, 28 of the lower and upper data library units respectively are shown), the tray 12 is expected to move the full vertical height of the stack under the control of the control system. A flexible cable such as a flexible flat cable (FFC) 60 connects a printed circuit board (PCB) on the tray 12 to a PCB connected to a motherboard at a fixed location (not shown), providing communication and power lines to the tray 12. The FFC 60 must be able to extend and retract accordingly as the tray 12 moves farther or nearer the motherboard respectively.

To avoid the FFC 60 experiencing increasing tension when the FFC 60 is extended due to the transmission apparatus 10 moving farther from the motherboard, there is provided a spooler or spooler mechanism 62 typically disposed at a fixed location within the stack of data library units as shown FIG. 9. The spooler 62 is provided for extendably and retractably storing the FFC 60 therein while the tray 12 moves vertically up and down serving the data library units in the stack. As the tray 12 moves further away from the spooler 62, the FFC 60 extends out of the spooler 62. As the tray 12 moves nearer the spooler 62, the FFC 60 retracts into the spooler 62 to avoid entanglement or obstruction of the FFC 60 with other components within the data library unit.

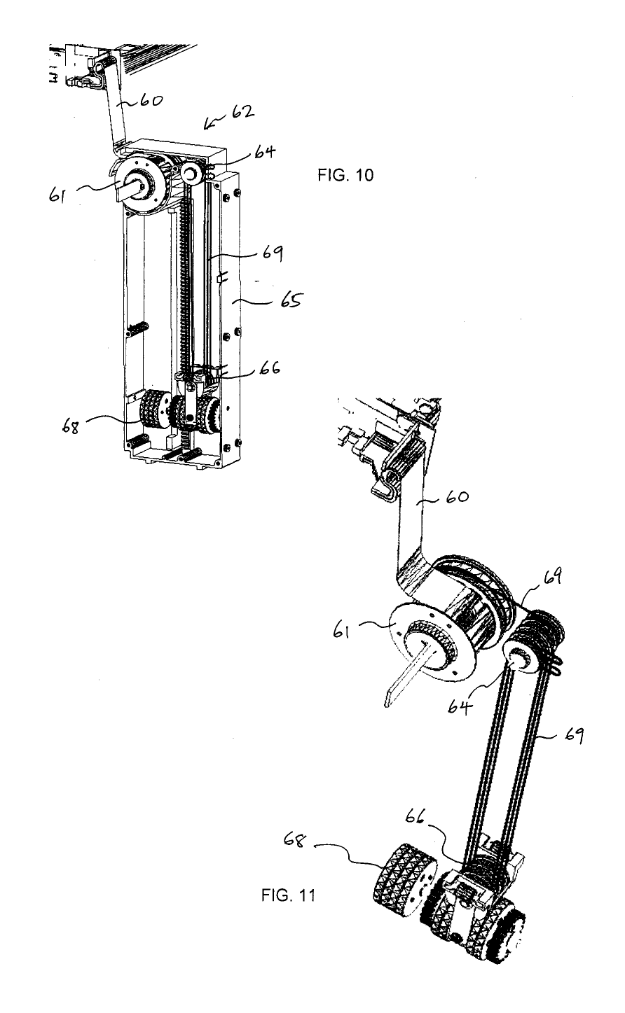

As shown in FIGS. 10 and 11, the spooler 62 comprises a weight 68 attached to a spool 61 by a wire rope or cable 69 that is passed through a number of pulleys 64, 66 to form a pulley system 64, 66, 69. The weight 68 is effectively a dead weight 68 and may be in the form of a stack of weighted discs as shown. The pulley system 64, 66, 69 comprises a top pulley arrangement 64 and a bottom pulley arrangement 66 around both of which the cable 69 is wound. The weight 68 provides a constant downward force due to gravity. This force provides a turning moment to rotate the spool 61 in one direction, for example, in a clockwise direction. The weight 68 thus provides the retractive force to retract the FFC 60 into the spooler 62 and to be wound around the spool 61. The retractive force is constant regardless of the amount of extension or retraction of the FFC 60 as the tray 12 moves up and down within the stack of data library units.

When the FFC 60 extends out of the spooler 62 as the tray 12 moves farther away from the spooler 62 and accordingly the spool 61, the FFC 60 is unwound from the spool 61 while the cable 69 is wound up around the spool 61. This causes the weight 68 to rise within the housing 65 of the spooler 62 towards the top pulley arrangement 64 as the length of cable 69 between the top and bottom pulley arrangements 64, 66 is shortened due to uptake of the cable 69 around the spool 61. When the tray 12 moves to approach the spooler 62 and accordingly the spool 61, tension on the cable 69 due to the weight 68 causes the FFC 60 to be wound back around the spool 61 while the cable 69 unwinds from the spool 61 and the weight 68 is accordingly lowered from the top pulley arrangement 64.

As a result of the pulley system 64, 66, 69, frictional losses will be almost similar regardless of movement direction of the tray 12, whether the FFC 60 is being extended or retracted with respect to the spooler 62. At the same time, the FFC 60 is either extended or retracted at a consistent force provided by the constant weight 68. This prolongs the life of the FFC 60 compared to prior art that experiences increasing tension when an extension spring is used to provide the retractive force to the FFC to be wound up around the spool.

With the pulley system 64, 66, 69, the spool 61 can store a required or suitable length of the FFC 60 which can be pulled out or extended sufficiently to accommodate a 4-stacked product configuration. Where a triple-double pulley system is used, tension on the FFC 60 due to the constant weight 68 is reduced by six times. Another advantage of using a triple-double pulley system is that the length of FFC 60 that can be pulled out or extended from the spooler 62 is also six times the maximum movement of the weight 68 within the housing 65. For example, for every upward movement of 100 mm of the weight 68, the FFC 60 can be pulled out or extended by 100×6=600 mm. In this way, height of the spooler 62 required to accommodate travel of the weight 68 therein can be accordingly reduced. In one embodiment, maximum movement of the weight 68 is 165 mm which translates to a FFC 60 pullout length of 990 mm. This is sufficient to cover a stack of four data library units.

Whilst there has been described in the foregoing description exemplary embodiments of the present invention, it will be understood by those skilled in the technology concerned that many variations in details of design, construction and/or operation may be made without departing from the present invention. For example, while a triple-double pulley system has been described, other pulley configurations can be used to provide a particular desired mechanical advantage. While the partial rack has been described and drawn to comprise one upper tooth and one lower tooth, a plurality of upper teeth and lower teeth may be provided.

1. A transmission apparatus for use in a stack of data library units, the stack comprising a lower data library unit and an upper data library unit, each data library unit of the stack comprising a plurality of upright frames, the transmission apparatus comprising:
a tray for transporting a tape cartridge;
a plurality of positioning pinions rotatably attached to the tray;
a plurality of racks each disposed on each of the plurality of upright frames and configured to be engaged by the corresponding plurality of positioning pinions for vertical positioning of the tray within each data library unit;
a plurality of partial racks each comprising an upper tooth and a lower tooth disposed adjacent the plurality of racks at each of the plurality of upright frames, the upper tooth being disposed adjacent a lower end of the frame of the upper data library unit and the lower tooth being disposed adjacent an upper end of the frame of the lower data library unit;
a plurality of cross-over pinions each rotatably attached to the tray and disposed co-axially with each of the plurality of positioning pinions, each cross-over pinion having a tooth profile configured to engage each of the partial racks for effecting movement of the tray between the lower data library unit and the upper data library unit.

2. The transmission apparatus of claim 1, wherein the positioning pinions are corotational with the plurality of cross-over pinions.

3. The transmission apparatus of claim 1, wherein the plurality of racks are toothless when adjacent the plurality of partial racks.

4. The transmission apparatus of claim 1, further comprising a plurality of bearings attached to the tray and configured to engage a corresponding plurality of vertically disposed surfaces provided in the corresponding plurality of frames, each of the plurality of bearings being disposed coaxially with each of the plurality of positioning pinions such that an optimal horizontal distance between the plurality of positioning pinions and corresponding plurality of racks is maintained during movement of the tray.

5. The transmission apparatus of claim 1, wherein a lower surface of the upper tooth is materially reduced to avoid interference between a tooth of the cross-over pinion and the partial rack when a pitch to pitch distance between the upper tooth and the lower tooth is minimized.

6. The transmission apparatus of claim 1, wherein an upper surface of a tooth of the cross-over pinion is materially reduced to avoid interference between the tooth of the cross-over pinion and the partial rack when a pitch to pitch distance between the upper tooth and the lower tooth is minimized.

7. A transmission apparatus for use in a stack of data library units, the stack comprising a lower data library unit and an upper data library unit, the transmission apparatus comprising:
a tray for transporting a tape cartridge;
a flexible cable communicatively connecting the tray and a motherboard;
a spool for winding the flexible cable therearound to retract the flexible cable when the tray moves towards the spool and unwinding the flexible cable therefrom to extend the flexible cable when the tray moves away from the spool; and
a weight configured to provide a constant retractive force to wind the flexible cable around the spool.

8. The transmission apparatus of claim 7, wherein the spool is rotatably connected to the weight via a cable of a pulley system.

9. The transmission apparatus of 8, wherein the cable is configured to wind up around the spool when the flexible cable is unwound from the spool.

10. The transmission apparatus of 7, wherein the weight is configured to rotate the spool in one direction while extension of the flexible cable due to movement of the tray away from the spool is configured to rotate the spool in an opposite direction.

11. A stack of data library units comprising the transmission apparatus of claim 1.

12. A stack of data library units comprising the transmission apparatus of claim 7.
